(19) United States
(12) Patent Application Publication
(10) Pub. No.: US 2026/0270434 A1
(43) Pub. Date: Sep. 10, 2026

(54) ADAPTIVE SAMPLE CLIPPING

(71) Applicant: MEDIATEK INC., Hsinchu City (TW)

(72) Inventors: Olena CHUBACH, San Jose, CA (US); Yi-Wen CHEN, San Jose, CA (US); Ching-Yeh CHEN, Hsinchu City (TW); Chih-Wei HSU, Hsinchu City (TW); Yu-Wen HUANG, Hsinchu City (TW)

(21) Appl. No.: 19/472,640

(22) PCT Filed: Jun. 28, 2024
(86) PCT No.: PCT/CN2024/102657

§ 371 Date: Oct. 4, 2025

Related U.S. Application Data
(60) Provisional application No. 63/510,931, filed on Jun. 29, 2023.

(51) Int. Cl. H04N 19/132; H04N 19/172; H04N 19/176; H04N 19/182; H04N 19/186; H04N 19/70

(52) U.S. Cl. CPC H04N 19/132; H04N 19/172; H04N 19/176; H04N 19/182; H04N 19/186; H04N 19/70

(57) ABSTRACT

A method for implementing sample clipping in a video coding system is provided. A video coder receives data to be encoded or decoded as a current block of pixels of a current picture of a video. The video coder signals or receives a first set of range definitions. The video coder encodes or decodes the current block by processing the received data in one or more coding stages, during which data samples produced by a first coding stage are constrained by adaptive sample clipping to be within a first numerical range defined by the first set of range definitions. The first set of range definitions may apply a clipping function upon the data samples produced by the first coding stage to impose a maximum allowed value and a minimum allowed value upon data samples produced by the first coding stage.

### CROSS REFERENCE TO RELATED PATENT APPLICATION(S)

The present disclosure is part of a non-provisional application that claims the priority benefit of U.S. Provisional Patent Application No. 63/510,931, filed on 29 Jun. 2023. Content of above-listed applications are herein incorporated by reference.

### TECHNICAL FIELD

The present disclosure relates generally to video coding. In particular, the present disclosure relates to methods of coding pixel blocks by adaptive sample clipping.

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs).

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). The leaf nodes of a coding tree correspond to the coding units (CUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quad-tree partitioning, vertical binary tree partitioning, horizontal binary tree partitioning, vertical center-side triple-tree partitioning, horizontal center-side triple-tree partitioning.

Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one-color component associated with CTU, CU, PU, and TU, respectively. Thus, a CTU consists of one luma CTB, two chroma CTBs, and associated syntax elements. A similar relationship is valid for CU, PU, and TU.

For each inter-predicted CU, motion parameters consisting of motion vectors, reference picture indices and reference picture list usage index, and additional information are used for inter-predicted sample generation. The motion parameter can be signaled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU. The alternative to merge mode is the explicit transmission of motion parameters, where motion vector, corresponding reference picture index for each reference picture list and reference picture list usage flag and other needed information are signaled explicitly per each CU.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide a method for implementing sample clipping in a video coding system. A video coder receives data to be encoded or decoded as a current block of pixels of a current picture of a video. The video coder signals or receives a first set of range definitions. The video coder encodes or decodes the current block by processing the received data in one or more coding stages, during which data samples produced by a first coding stage are constrained by adaptive sample clipping to be within a first numerical range defined by the first set of range definitions. The first set of range definitions may apply a clipping function upon the data samples produced by the first coding stage to impose a maximum allowed value and a minimum allowed value upon data samples produced by the first coding stage.

In some embodiments, the maximum and minimum allowed values are applicable to luma and chroma components. In some embodiments, the maximum and minimum allowed values are applicable to samples of luma component only and not samples of chroma components. In some embodiments, data samples produced by a second coding stage are constrained to also be within the first numerical range defined by the first set of range definitions. In other words, a same set of maximum and minimum values are applied to multiple stages.

The video encoder may also signal a second set of range definitions, such that data samples produced by a second coding stage are constrained to be within a second numerical range defined by the second set of range definitions. In other words, different sets of maximum and minimum values may be applied to different stages. In some embodiments, the first set of range definitions is one set of a plurality of sets of range definitions signaled by the encoder, and the encoder selects the first set of range definitions from the plurality of sets of range definitions to be applied to the data samples produced by the first coding stage.

In some embodiments, the first set of range definitions is used for luma mapping with chroma scaling (LMCS), i.e., for defining a first range for mapping luma values from an original domain to a reshaped domain. The first set of range definitions may include a maximum value and a minimum value that is used for defining the first range and a number of non-zero codewords, and the number of non-zero codewords may not be a power of two number. A second set of range definitions may be used to define a second range for mapping luma values from the original domain to the reshaped domain.

In some embodiments, when adaptive sample clipping is applied, LMCS is disabled, and when LMCS is applied, adaptive sample clipping is disabled. In some embodiments, when LMCS is enabled, adaptive sample clipping is used in an in-loop filter stage (e.g., deblocking, adaptive loop filtering, sample adaptive offset). In some embodiments, when LMCS is disabled, adaptive sample clipping is applied to a prediction stage or a reconstruction stage of video encoding.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 shows luma mapping with chroma scaling (LMCS) architecture in a video decoder.

FIG. 2 conceptually illustrates using maximum and minimum values to define a reshaped domain for LMCS.

FIG. 3 illustrates an example video encoder that may implement adaptive sample clipping.

FIG. 4 conceptually illustrates portions of the video encoder that implement controlled clipping.

FIG. 5 conceptually illustrates a process for performing adaptive sample clipping during video encoding.

FIG. 6 illustrates an example video decoder that may implement adaptive sample clipping.

FIG. 7 conceptually illustrates portions of the video decoder that implement controlled clipping.

FIG. 8 conceptually illustrates a process for performing adaptive sample clipping during video decoding.

FIG. 9 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. Luma Mapping with Chroma Scaling (LMCS)

Luma mapping with chroma scaling (LMCS) is a coding tool that may operate as a processing block before the loop filters (SAO, DBF, etc.) in the video coding loop. LMCS has two main component functions: 1) in-loop mapping of the luma component based on adaptive piecewise linear models, and 2) luma-dependent chroma residual scaling for the chroma components.

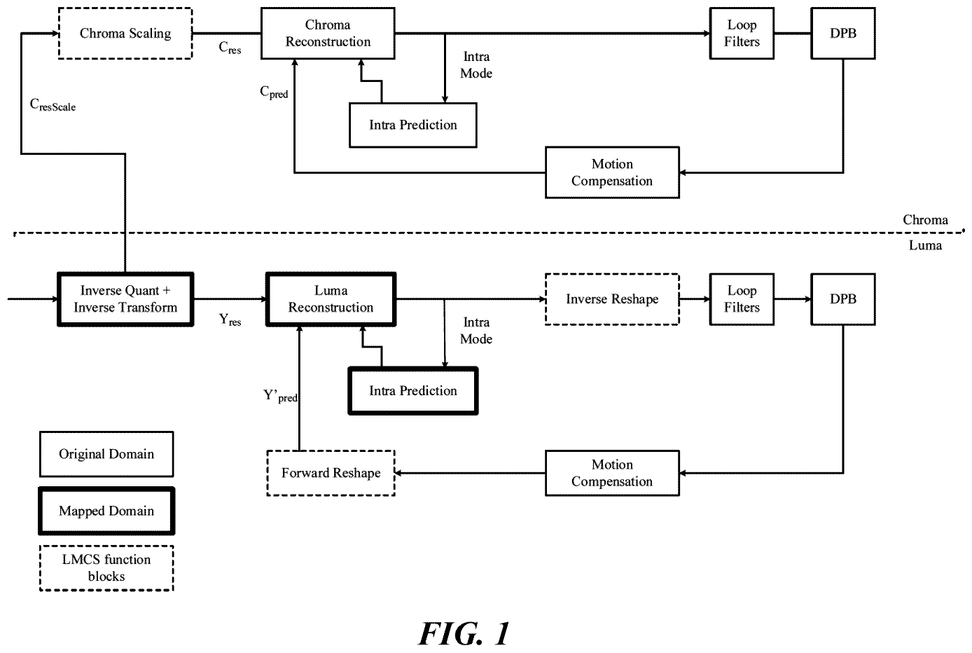

FIG. 1 shows luma mapping with chroma scaling (LMCS) architecture in a video decoder. Some blocks correspond to processing being applied in the mapped (or reshaped) domain; and these include the inverse quantization, inverse transform, luma intra prediction and adding of the luma prediction together with the luma residual. Some blocks in the figure are where the processing is applied in the original (i.e., non-mapped) domain; and these include loop filters such as deblocking, ALF, and SAO, motion compensated prediction, chroma intra prediction, adding of the chroma prediction together with the chroma residual, and storage of decoded pictures as reference pictures. Some blocks in the figure are the LMCS functional blocks, including forward and inverse mapping of the luma signal and a luma-dependent chroma scaling process. Like most other tools in VVC, LMCS can be enabled/disabled at the sequence level using an SPS flag.

The in-loop mapping of the luma component adjusts the dynamic range of the input signal by redistributing the codewords across the dynamic range to improve compression efficiency. Luma mapping makes use of a forward mapping function, FwdMap, and a corresponding inverse mapping function, InvMap. The FwdMap function is signaled using a piecewise linear model with 16 equal pieces. InvMap function does not need to be signaled and is instead derived from the FwdMap function.

a. Luma Mapping with Piecewise Linear Model

A luma mapping model may be signaled in the adaptation parameter set (APS) syntax structure with aps_params_type set equal to 1 (LMCS_APS). Up to 4 LMCS APS's can be used in a coded video sequence. Only 1 LMCS APS can be used for a picture. The luma mapping model is signaled using piecewise linear model. The piecewise linear model partitions the input signal's dynamic range into 16 equal pieces, and for each piece, its linear mapping parameters are expressed using the number of codewords assigned to that piece. Take 10-bit input as an example. Each of the 16 pieces will have 64 codewords assigned to it by default. The signaled number of codewords is used to calculate the scaling factor and adjust the mapping function accordingly for that piece. At the slice level, an LMCS enable flag is signaled to indicate if the LMCS process as depicted in FIG. 1 is applied to the current slice. If LMCS is enabled for the current slice, an aps_id is signaled in the slice header to identify the APS that carries the luma mapping parameters.

Each i-th piece, i=0 . . . 15, of the FwdMap piecewise linear model is defined by two input pivot points InputPivot[ ] and two output (mapped) pivot points MappedPivot[ ]. The InputPivot[ ] and MappedPivot[ ] are computed as follows (assuming 10-bit video):

```
(1) OrgCW = 64
(2) For i = 0:16, InputPivot[ i ] = i * OrgCW
(3) For i=0:16, MappedPivot[i] is calculated as follows:
    MappedPivot[ 0 ] = 0;
    for( i = 0; i <16 ; i++)
      MappedPivot[ i + 1 ] = MappedPivot[ i ] + SignaledCW[ i ]
```

where OrgCW is the original number of code words (same for all i) and SignaledCW[i] is the signaled number of codewords for the i-th piece.

As shown in FIG. 1, for an inter-coded block, motion compensated prediction is performed in the mapped domain. In other words, after the motion-compensated prediction block Y_{pred} is calculated based on the reference signals in the DPB, the FwdMap function is applied to map the luma prediction block in the original domain to the mapped domain, Y′_{pred}=FwdMap(Y_{pred}). For an intra-coded block, the FwdMap function is not applied because intra prediction is performed in the mapped domain. After reconstructed block Yᵣ is calculated, the InvMap function is applied to convert the reconstructed luma values in the mapped domain back to the reconstructed luma values in the original domain (Ŷᵢ=InvMap(Yᵣ)). The InvMap function is applied to both intra- and inter-coded luma blocks.

The luma mapping process (forward and/or inverse mapping) can be implemented using either look-up-tables (LUT) or using on-the-fly computation. If LUT is used, then FwdMapLUT and InvMapLUT can be pre-calculated and pre-stored for use at the tile group level, and forward and inverse mapping can be simply implemented as FwdMap(Y_{pred})=FwdMapLUT[Y_{pred}] and InvMap(Yᵣ)=InvMapLUT[Yᵣ], respectively. Alternatively, on-the-fly computation may be used. Take forward mapping function FwdMap as an example. In order to figure out the piece to which a luma sample belongs, the sample value is right shifted by 6 bits (which corresponds to 16 equal pieces). Then, the linear model parameters for that piece are retrieved and applied on-the-fly to compute the mapped luma value. Let i be the piece index, a1, a2 be InputPivot[i] and InputPivot[i+1], respectively, and b1, b2 be MappedPivot[i] and MappedPivot[i+1], respectively. The FwdMap function is evaluated as follows:

$$FwdMap ( {Y}_{pred} ) = ( ( b 2 - b 1 ) / ( a 2 - a 1 ) ) * ( {Y}_{pred} - a 1 ) + b 1$$

The InvMap function can be computed on-the-fly in a similar manner. Generally, the pieces in the mapped domain are not equal sized, therefore the most straightforward inverse mapping process would require comparisons in order to figure out to which piece the current sample value belongs. Such comparisons increase decoder complexity. For this reason, a bitstream constraint is imposed on the values of the output pivot points MappedPivot[i] as follows:

Assume the range of the mapped domain (for 10-bit video, this range is [0, 1023]) is divided into 32 equal pieces. If MappedPivot[i] is not a multiple of 32, then MappedPivot[i+1] and MappedPivot[i] cannot belong to the same piece of the 32 equal-sized pieces, i.e. MappedPivot[i+1](BitDepth_{Y}−5) shall not be equal to MappedPivot[i](BitDepth_{Y}−5).

By using such bitstream constraint, the InvMap function can also be carried out using a simple right bit-shift by 5 bits (which corresponds 32 equal-sized pieces) in order to figure out the piece to which the sample value belongs.

b. Luma-Dependent Chroma Residual Scaling

Chroma residual scaling is used to compensate for the interaction between the luma signal and its corresponding chroma signals. Whether chroma residual scaling is enabled or not may be signaled at the slice level. If luma mapping is enabled, an additional flag is signaled to indicate if luma-dependent chroma residual scaling is enabled or not. In some embodiments, when luma mapping is not used, luma-dependent chroma residual scaling is disabled. Further, luma-dependent chroma residual scaling is always disabled for the chroma blocks whose area is less than or equal to 4.

Chroma residual scaling depends on the average value of top and/or left reconstructed neighboring luma samples of the current VPDU. If the current CU is inter 128×128, inter 128×64 and inter 64×128, then the chroma residual scaling factor derived for the CU associated with the first VPDU is used for all chroma transform blocks in that CU. The value of C_{ScaleInv} is computed in the following steps: (avgYr denotes the average of the reconstructed neighboring luma samples as shown in FIG. 1.)
(1) Find the index Y_{idx} of the piecewise linear model to which avgYr belongs based on the InvMap function.
(2) C_{ScaleInv}=cScaleInv[Y_{Idx}], where cScalelnv[ ] is a 16-piece LUT pre-computed based on the value of SignaledCW[i] and a offset value signaled in APS for chroma residual scaling process.

Unlike luma mapping, which is performed on the sample basis, C_{ScaleInv} is a constant value for the entire chroma block. With C_{ScaleInv}, chroma residual scaling is applied as follows:

$$Encoder side : {C}_{ResScale} = {C}_{Res} * {C}_{Scale} = {C}_{Res} / {C}_{ScaleInv} \\ Decoder side : {C}_{Res} = {C}_{ResScale} / {C}_{Scale} = {C}_{ResScale} * {C}_{ScaleInv}$$

c. LMCS Coding Process

In some embodiments, LMCS data is signaled/coded in the bitstream. Syntax elements for the coded LMCS data includes minimum bin index, delta maximum bin index, delta number of codewords in each interval (or range), and chroma scaling corrective offset. A syntax table for LMCS data in APS is provided as follows:

| | Descriptor |
|---|---|
| lmcs_data( ) { | |
| lmcs_min_bin_idx | ue(v) |
| lmcs_delta_max_bin_idx | ue(v) |
| lmcs_delta_cw_prec_minus1 | ue(v) |
| for (I = lmcs_min_bin_idx; i<=LmcsMaxBinIdx;=++) | |
| { | |
| lmcs_delta_abs_cs [i] | u(v) |
| if ( lmcs_delta_abs_cw[ i ] ) > 0 ) | |
| lmcs_delta_sign_cw_flag[ i ] | u(1) |
| } | |
| if( aps_chroma_present_flag ) { | |
| lmcs_delta_abs_crs | u(3) |
| If (lmcs_delta_abs_crs > 0) | |
| lmcs_delta_sign_crs_flag | u(1) |
| } | |
| } | |

### II. Controlled Clipping/Adaptive Sample Clipping

A video system may perform some of its functions by adapting to the statistics of input signals. This adaptivity is evident in the motion interpolation design, which incorporates sets of filters to accommodate different signal characteristics, and in the adaptive loop filter design that allows an encoder to design and transmit a loop filter to the decoder. The additional adaptivity provides increased coding efficiency for many sequences. Unfortunately, it also results in dynamic range expansion. For image sequences that are transmitted at full range, e.g., [0,255] in 8-bit, this dynamic range expansion is not an issue. The decoding process currently restricts intermediate values to the full range, and so any dynamic range expansion is handled implicitly.

A problem occurs when the input data does not use full range. One very common scenario is when image data are stored with “broadcast legal values”. For example, the luma signal may be originally in the range [16, 235], and the chroma signal may be originally in the range [16, 240]. After coding by the video coding system, the reconstructed pixel values are no longer in this range and may exceed the range of the input values.

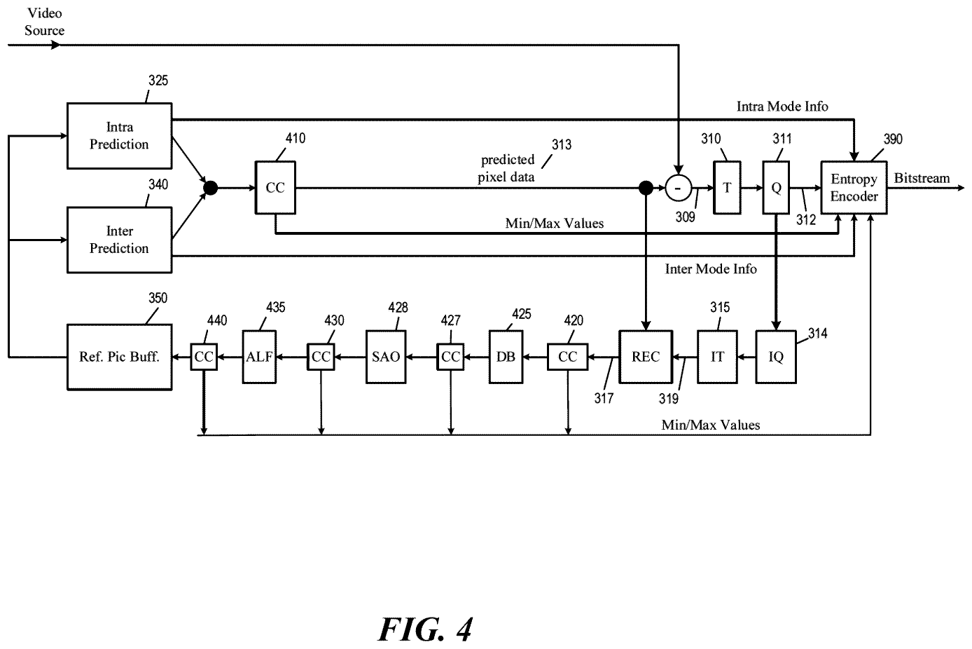

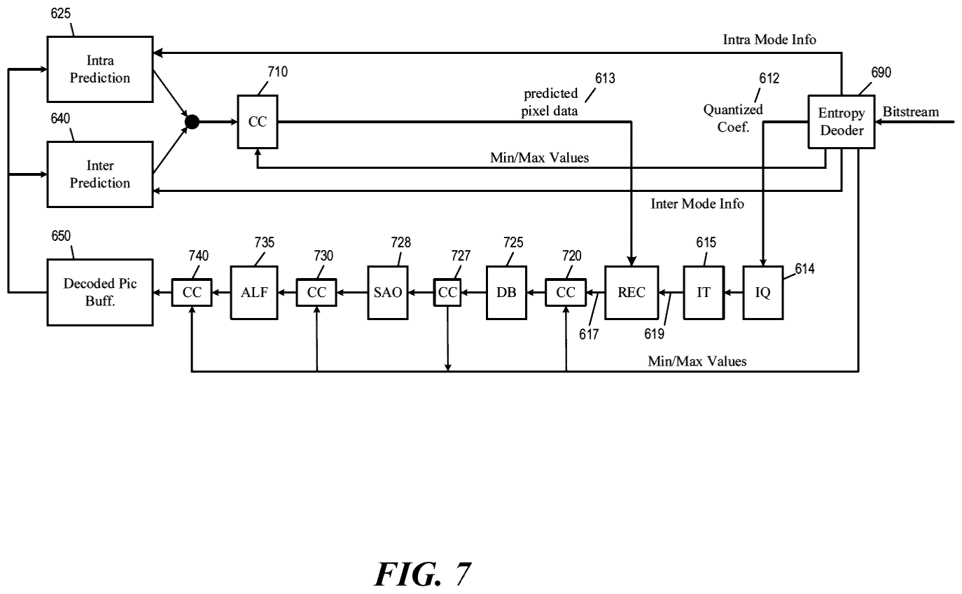

In some embodiments, a video coding system performs “controlled clipping” or “adaptive sample clipping”. Specifically, an encoder transmits a known range of the luma and chroma values to the decoder, and the decoder use the transmitted range values as clipping points (e.g., as maximum and minimum) to limit data samples to certain defined ranges of allowed values. Clipping points may operate at various stages of the coding process, e.g., after prediction, after reconstruction, after deblocking, and after adaptive loop filter processes. The video coding stages at which the controlled clipping may be implemented will be described by reference to FIG. 4 and FIG. 7 below.

In some embodiments, controlled clipping operates by a range (minimum and maximum values) of original pixels in the current picture to decoders. If a pixel value is out of the specified range after reconstruction, the pixel value will be clipped to the minimum or the maximum. The minimum and maximum may be predicted before transmission.

In some embodiments, a video coder uses 4-stage controlled clipping by using a Clip3 function that restricts the original values to the range of [min_value, max_value]. For some embodiments, the Clip3 function may be defined according to the following equation:

```
Clipped_value = Clip3(min_value, max_value, orig_value)
such that Clipped_value =
  orig_value if min_value ≤ orig_value ≤ max_value
  min_value if orig_value ≤ min_value
  max_value if orig_value ≥ max_value
```

In some embodiments, corresponding video encoders and decoders implement controlled clipping at various encoding and decoding stages. For example, in some embodiments, video encoders and decoders implement controlled clipping at post-prediction, at post-reconstruction, at post-deblocking, and at post-ALF. Controlled clipping implemented in coding stages of the video encoder is described by reference to FIGS. 4 and 7 below.

In some embodiments, the controlled clipping minimum and maximum values may be defined at picture parameter set (PPS) level or slice level. When the PPS-level adaptation is used, the minimum and maximum values can be sent in PPS or predefined by setting a broadcast legal flag to 1. The slice-level adaptation can be enabled for luma and chroma separately. When the slice-level adaptation is enabled, the minimum and maximum values conveyed in PPS are used for prediction of those in slice header. Syntax and semantics of the approach are shown in the following syntax tables:

### Syntax for Controlled Clipping in PPS:

| | C | Descriptor |
|---|---|---|
| pic_parameter_set_rbsp( ) { | | |
| ... | | |
| controlled_clipping_flag | 1 | u(1) |
| if( controlled_clipping_flag ) | | |
| { | | |
| controlled_clipping_broadcast_legal_flag | 1 | u(1) |
| if( !controlled_clipping_broadcast_legal_flag ) | | |
| { | | |
| controlled_clipping_minY | 1 | u(v) |
| controlled_clipping_maxY | 1 | u(v) |
| controlled_clipping_minCr | 1 | u(v) |
| controlled_clipping_maxCr | 1 | u(v) |
| controlled_clipping_sameC_data_flag | 1 | u(1) |
| if( !controlled_clipping_sameC_data_flag ) | | |
| { | | |
| controlled_clipping_minCb | 1 | u(v) |
| controlled_clipping_maxCb | 1 | u(v) |
| } | | |
| } | | |
| controlled_clipping_slice_controlY_flag | 1 | u(1) |
| controlled_clipping_slice_controlC_flag | 1 | u(1) |
| } | | |
| ... | | |
| } | | |

### Syntax for Controlled Clipping in Slice Header:

| | C | Descriptor |
|---|---|---|
| slice_header( ) { | | |
| ... | | |
| if( controlled_clipping_slice_controlY_flag ) | | |
| { | | |
| controlled_clipping_minY_slice_delta | 2 | se(v) |
| controlled_clipping_maxY_slice_delta | 2 | se(v) |
| } | | |
| if( controlled_clipping_slice_controlC_flag ) | | |
| { | | |
| controlled_clipping_minCr_slice_delta | 2 | se(v) |
| controlled_clipping_maxCr_slice_delta | 2 | se(v) |
| controlled_clipping_minCb_slice_delta | 2 | se(v) |
| controlled_clipping_maxCb_slice_delta | 2 | se(v) |
| } | | |
| ... | | |
| } | | |

controlled_clipping_flag equal to 1 denotes that controlled clipping is enabled; equal to 0 denotes that controlled clipping is disabled.

controlled_clipping_broadcast_legal_flag equal to 1 denotes that predefined minimum and maximum pixel values are used for controlled clipping; equal to 0 denotes that transmitted minimum and maximum pixel values are used for controlled clipping.

controlled_clipping_minY defines the minimum pixel value for Y channel. When controlled_clipping_broadcast_legal_flag is equal to 1, controlled_clipping_minY shall be (16<<K bit_depth_luma_minus8). When controlled_clipping_flag is equal to 0, controlled_clipping_minY shall be 0.

controlled_clipping_maxY defines the maximum pixel value for Y channel. When controlled_clipping_broadcast_legal_flag is equal to 1, controlled_clipping_maxY shall be (235<<bit_depth_luma_minus8). When controlled_clipping_flag is equal to 0, controlled_clipping_maxY shall be (255<<bit_depth_luma_minus8).

controlled_clipping_minCr defines the minimum pixel value for Cr channel. When controlled_clipping_broadcast_legal_flag is equal to 1, controlled_clipping_minCr shall be (16<<bit_depth_chroma_minus8). When controlled_clipping_flag is equal to 0, controlled_clipping_minCr shall be 0.

controlled_clipping_maxCr defines the maximum pixel value for Cr channel. When controlled_clipping_broadcast_legal_flag is equal to 1, controlled_clipping_maxCr shall be (240<<bit_depth_chroma_minus8). When controlled_clipping_flag is equal to 0, controlled_clipping_maxCr shall be (255<<bit_depth_chroma_minus8).

controlled_clipping_sameC_data_flag equal to 1 denotes that controlled clipping parameters in PPS are the same for both chroma channels.

controlled_clipping_minCb defines the minimum pixel value for Cb channel. When controlled_clipping_broadcast_legal_flag is equal to 1, controlled_clipping_minCb shall be (16<<bit_depth_chroma_minus8). When controlled_clipping_sameC_data_flag is equal to 1, controlled_clipping_minCb shall be controlled_clipping_minCr. When controlled_clipping_flag is equal to 0, controlled_clipping_minCb shall be 0.

controlled_clipping_maxCb defines the maximum pixel value for Cb channel. When controlled_clipping_broadcast_legal_flag is equal to 1, controlled_clipping_maxCb shall be (240<<bit_depth_chroma_minus8). When controlled_clipping_sameC_data_flag is equal to 1, controlled_clipping_maxCb shall be controlled_clipping_maxCr. When controlled_clipping_flag is equal to 0, controlled_clipping_maxCb shall be (255<<bit_depth_chroma_minus8).

controlled_clipping_slice_controlY_flag equal to 1 denotes that slice-level controlled clipping is enabled for luma; equal to 0 denotes that PPS-level controlled clipping is enabled for luma.

controlled_clipping_slice_controlC_flag equal to 1 denotes that slice-level controlled clipping is enabled for chroma; equal to 0 denotes that PPS-level controlled clipping is enabled for chroma.

controlled_clipping_minY_slice_delta is used to derive controlled_clipping_minY_slice as follows.

controlled_clipping_minY_slice=controlled_clipping_minY+controlled_clipping_minY_slice_delta

When controlled_clipping_slice_controlY_flag is equal to 0 or when controlled_clipping_flag is equal to 0, controlled_clipping_minY_slice shall be controlled_clipping_minY In the current slice, channel Y pixel values smaller than controlled_clipping_minY_slice shall be replaced by controlled_clipping_minY_slice.

controlled_clipping_maxY_slice_delta is used to derive controlled_clipping_maxY_slice as follows.

controlled_clipping_maxY_slice=controlled_clipping_maxY+controlled_clipping_maxY_slice_delta

When controlled_clipping_slice_controlY_flag is equal to 0 or when controlled_clipping_flag is equal to 0, controlled_clipping_maxY_slice shall be controlled_clipping_maxY In the current slice, channel Y pixel values larger than controlled_clipping_maxY_slice shall be replaced by controlled_clipping_maxY_slice.

controlled_clipping_minCr_slice_delta is used to derive controlled_clipping_minCr_slice as follows.

controlled_clipping_minCr_slice=controlled_clipping_minCr+controlled_clipping_minCr_slice_delta

When controlled_clipping_slice_controlC_flag is equal to 0 or when controlled_clipping_flag is equal to 0, controlled_clipping_minCr_slice shall be controlled_clipping_minCr. In the current slice, channel Cr pixel values smaller than controlled_clipping_minCr_slice shall be replaced by controlled_clipping_minCr_slice.

controlled_clipping_maxCr_slice_delta is used to derive controlled_clipping_maxCr_slice as follows.

controlled_clipping_maxCr_slice=controlled_clipping_maxCr+controlled_clipping_maxCr_slice_delta

When controlled_clipping_slice_controlC_flag is equal to 0 or when controlled_clipping_flag is equal to 0, controlled_clipping_maxCr_slice shall be controlled_clipping_maxCr. In the current slice, channel Cr pixel values larger than controlled_clipping_maxCr_slice shall be replaced by controlled_clipping_maxCr_slice.

controlled_clipping_minCb_slice_delta is used to derive controlled_clipping_minCb_slice as follows.

controlled_clipping_minCb_slice=controlled_clipping_minCb+controlled_clipping_minCb_slice_delta

When controlled_clipping_slice_controlC_flag is equal to 0 or when controlled clipping flag is equal to 0, controlled_clipping_minCb_slice shall be controlled_clipping_minCb. In the current slice, channel Cb pixel values smaller than controlled_clipping_minCb_slice shall be replaced by controlled_clipping_minCb_slice.

controlled_clipping_maxCb_slice_delta is used to derive controlled_clipping_maxCb_slice as follows.

controlled_clipping_maxCb_slice=controlled_clipping_maxCb+controlled_clipping_maxCb_slice_delta

When controlled_clipping_slice_controlC_flag is equal to 0 or when controlled_clipping_flag is equal to 0, controlled_clipping_maxCb_slice shall be controlled_clipping_maxCb. In the current slice, channel Cb pixel values larger than controlled_clipping_maxCb_slice shall be replaced by controlled_clipping_maxCb_slice.

It is empirically observed that such a controlled clipping/adaptive sample clipping coding tools may result in dynamic range expansion of the reconstructed frame. This is problematic for sequences that do not use the entire input dynamic range, as the coding process may produce pixel values that are outside of the dynamic range of the source. To overcome this problem, in some embodiments, the clipping points are modified within the TM to account for the dynamic range of the input source (for when controlled clipping is applied at post-prediction, post-reconstruction, post-deblocking, and post-ALF.) This provides improved coding efficiency for most of the sequences and requires little increase in complexity. (Empirically, the BD rate reductions are 0.6% for the high efficiency random access configuration and 0.4% for the high efficiency low delay configuration.)

In some embodiments, Min and Max values (for defining a range) are defined, signaled by the encoder, and decoded by the decoder for specific color component(s) only. In one embodiment, Min and Max values defining a range are defined for Y (Luma) only. In some embodiments, Min and Max values are defined for Y (Luma), and additional flag is signaled by encoder and decoded by decoder (at APS, SPS, PPS, SH, or PH level), to identify, whether a similar clipping is applied to Cb/Cr (two chroma) components. In some embodiments, both components may share one range. In one embodiment, a separate flag is signaled by encoder and decoded by decoder (at APS, SPS, PPS, SH, or PH level) to indicate that all three components share the same range.

In some embodiments, adaptive sample clipping can be selectively applied at different stages during encoding and decoding process. Specifically, the decoding process may apply adaptive sample clipping at prediction stage (e.g., intra predictors generation, inter predictors generation), de-quantization stage, inverse-transform stage, in-loop filters stage (e.g. deblock, SAO, ALF), and/or other decoding stages.

In some embodiments, multiple sets of Min/Max values are defined and signaled by encoder and decoded by decoder, and each set of Min/Max clipping values can be applied at one or more than one stages. For example, one set of Min/Max values may be used for the adaptive sample clipping at ALF stage, while another set of Min/Max values are used for the adaptive sample clipping at DF or SAO stage. In some embodiments, adaptive sample clipping can be applied at multiple stages, with varying Min/Max values, depending on the stage/tool it is applied at. In some embodiments, Min/Max values from adaptive sample clipping are used at one or more loop filtering stages (e.g., ALF, SAO, Deblocking, etc.), with varying Min/Max values, depending on the stage/tool.

In some embodiments, the in-loop filtering tools are modified to consider different Min/Max values from the Adaptive Sample Clipping. In some embodiments, an additional flag can be signaled by the encoder and decoded by the decoder (at APS, SPS, PPS, SH, or PH level) indicating whether one or more than one ranges are used. In case if one range is decided to be used (at APS, SPS, PPS, SH, or PH level), either one of the available multiple sets of Min/Max values can be used. In some embodiments, a decision whether to use one or another of the available multiple sets of Min/Max values at a certain stage depends on the tool. For example, in some embodiments, Min/Max from set 1 are used at ALF stage, while Min/Max from set 2 are used DF or SAO stage.

In some embodiments, only one set (referred to as global set) of the multiple sets of Min/Max values are used by all tools at all stages, meaning the Min/Max range is defined at the encoder and then this range is used globally during all the encoding and decoding process. In this case, defined Min/Max are signaled by the encoder and decoded by the decoder, and then the decoded range is used during all decoding process, whenever a Clipping operation needs to be applied to preserve the defined range of decoded samples. In some embodiments, a separate flag is signaled by encoder and decoded by decoder (at APS, SPS, PPS, SH, or PH level) to indicate that one of the multiple sets of Min/Max values is used by all tools at all stages. In this case, a so-called “global” clipping range is used, e.g. for the whole sequence/picture/slice, etc.

In some embodiments, adaptive sample clipping can be extended to a slice/tile/CTU (row)/CU/block level. In some embodiments, on/off control is performed at any of the above levels. In some embodiments, multiple sets of Min/Max values can be encoded by an encoder, decoded/defined by decoder, and applied at slice/tile/CTU (row)/CU/block levels. In this case, any of the methods described in this invention can be extended accordingly.

In some methods, adaptive sample clipping is regarded as one mode of LMCS. When LMCS is enabled, one additional syntax element is signaled to indicate whether the adaptive sample clipping is enabled or not. When the adaptive sample clipping is enabled, all the aforementioned methods in this invention can be used for sample clipping.

In some embodiments, Min/Max values defined for Adaptive Sample Clipping can be used at LMCS stage. In some embodiments, the Min and Max values defined for Adaptive Sample Clipping can replace Min and Max values used in LMCS, such that instead of the range of 0 to ((1<<BitDepth)−1), range between the defined Min and Max is considered in LMCS, when operation of splitting into different ranges for luma mapping is applied. In some embodiments, number of ranges can be adjusted depending on the Min/Max range. In some embodiments, the signaled Min and Max values replace lmcs_min_bin_idx and lmcs_delta_max_bin_idx, which are used to define the range and number of non-zero codewords in original and/or reshaped domain. (In other words, the signaled Min and Max values are used to calculate MappedPivot[i] and SignaledCW[i] for different sections/ranges of the reshaped domain as described in Section La above.) In some embodiments, the Min and Max values are used to define lmcs_min_bin_idx and lmcs_delta_max_bin_idx (so no signaling is required for those syntax elements).

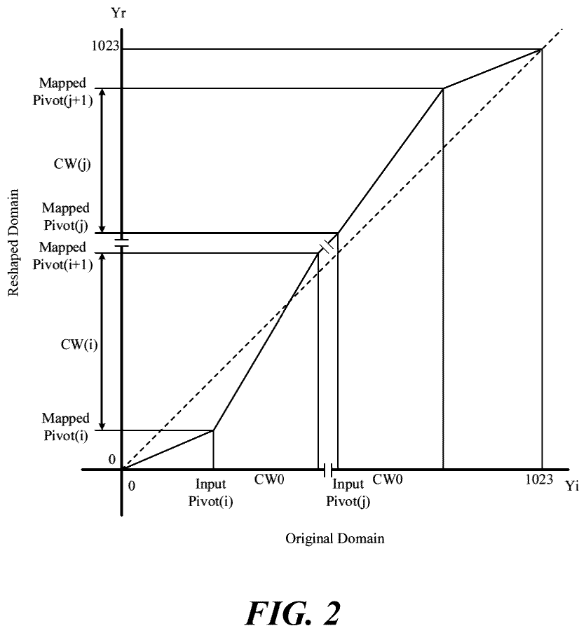

FIG. 2 conceptually illustrate using maximum and minimum values to define a reshaped domain for luma mapping with chroma scaling (LMCS). The figure illustrates a reshaping function for mapping of luma values from the original domain to the reshaped domain. The reshaping function is defined by input pivot points (InputPivot[i]) in the original domain and mapped pivot points (MappedPivot[i]) in the reshaped domain. The input pivots are evenly spaced in the original domain. The mapped pivots are spaced to accommodate different number of codewords in different ranges in the reshaped domain. In some embodiments, the distribution of the mapped pivot points may be defined by the one or more sets of Max and Min values that are signaled for adaptive sample clipping as described above. For example, in some embodiments, each set of Max and Min values is used to define one range in the reshaped domain by e.g. specifying one mapped pivot point and a number of codewords in the range.

In some embodiments, an additional delta syntax element can be signaled by encoder and decoded by decoder (e.g., at APS, SPS, PPS, SH, PH, or APS level) to enable any min/max values for any number of codewords for LMCS, not only multiple of 16. This would allow combining (LMCS off+Clipping on) and LMCS On cases. In some embodiment, an additional flag can be signaled by the encoder and decoded by the decoder (at APS, SPS, PPS, SH, PH, or APS level), to indicate, whether one of the multiple or multiple sets of Min/Max values are used in LMCS.

In some embodiments, LMCS and Adaptive sample Clipping are mutually exclusive. For example, in some embodiments, when Adaptive Sample Clipping is applied—LMCS is disabled. In some embodiments, when LMCS is applied—Adaptive Sample Clipping is disabled. In some embodiments, when LMCS is enabled, adaptive sample clipping is used in in-loop filter stage. In one embodiment, when LMCS is disabled, adaptive sample clipping is further applied to prediction and/or reconstruction stages.

In some embodiments, a separate syntax element is used to indicate whether LMCS or Adaptive sample Clipping is applied. In some embodiments a separate syntax element is encoded at encoder and decoded by decoder, e.g., at APS, SPS, PPS, SH, PH, or APS level. In some embodiments, adaptive sample clipping is applied whenever LMCS is disabled/not applied, e.g., at APS, SPS, PPS, SH, or PH level.

In some embodiments, the range (minimum and maximum) of original pixels is signaled in the SH, PH, APS, PPS or combined in LMCS syntax. In some embodiments, a difference between the original Min/Max and a predefined value can be signaled by encoder and decoded by decoder. In this case, at the decoder side, to reconstruct the original value of Min and Max, a predefined value needs to be known and added to the signaled value. In some embodiments, two separate predefined values are used—one for Min value and another one for Max value. In some embodiments, a set of predefined values is available at encoder and decoder, and additional syntax element can be signaled by encoder and decoded by decoder, to identify which one of the predefined values is used.

In some embodiments, a predefined Min and/or Max values are set for all color components. In some embodiments a predefined value is separately set for luma component and for two chroma components. In some embodiments, separate Min and Max values are set for each color component. In some embodiments, a separate flag is signaled to indicate whether or not Min and/or Max are shared by all color components (or two chroma components).

In some embodiments, the predefined values are signaled at SPS, PPS, SH, PH, or APS level. In some embodiments, a separate syntax element is used (at SPS, PPS, SH, PH, or APS level) to indicate whether the predefined values are signaled separately or default values are used. In some embodiments, SH (PH, picture) flag to enable/disable adaptive sample clipping at slice (PH, picture) level can be signaled at the encoder and decoded at the decoder. In some embodiments, Min and Max values for the current slice (picture) are signaled only when the SH (PH, picture) level flag is equal to 1 (not equal to 0).

In some embodiments, a slice (or picture header or picture) level decision can be made based on certain criteria, so no signaling is required at slice (or picture header or picture) level, and decision can be made at both, encoder and decoder without any additional signaling. In some embodiments, an SPS level flag to enable/disable adaptive sample clipping at sequence level can be signaled at the encoder and decoded at the decoder. In some embodiments, slice (or picture header or picture) level flag is signaled only when a sequence level flag is equal to 1 (not equal to 0).

In some embodiments, only samples before motion compensated temporal filtering (MCTF) (i.e., original unfiltered samples) are used for defining Min and Max. In some embodiments, samples after MCTF are used for adaptive clipping, and Min/Max value can be defined at the encoder and signaled by encoder and decoded by decoder. Other methods can be also used for defining multiple sets of Min/Max ranges for each frame.

### III. Example Video Encoder

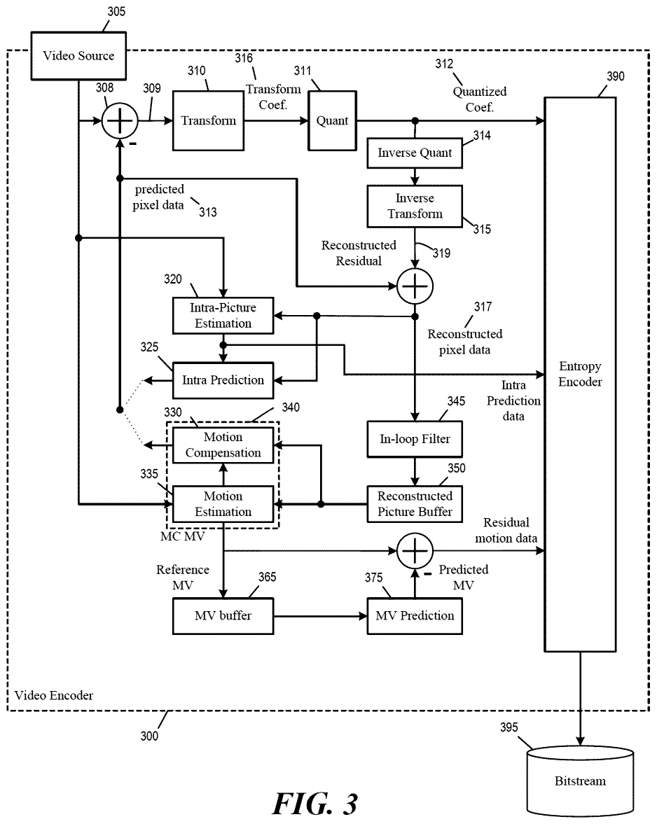

FIG. 3 illustrates an example video encoder 300 that may implement adaptive sample clipping. As illustrated, the video encoder 300 receives input video signal from a video source 305 and encodes the signal into bitstream 395. The video encoder 300 has several components or modules for encoding the signal from the video source 305, at least including some components selected from a transform module 310, a quantization module 311, an inverse quantization module 314, an inverse transform module 315, an intra-picture estimation module 320, an intra-prediction module 325, a motion compensation module 330, a motion estimation module 335, an in-loop filter 345, a reconstructed picture buffer 350, a MV buffer 365, and a MV prediction module 375, and an entropy encoder 390. The motion compensation module 330 and the motion estimation module 335 are part of an inter-prediction module 340.

In some embodiments, the modules 310-390 are modules of software instructions being executed by one or more processing units (e.g., a processor) of a computing device or electronic apparatus. In some embodiments, the modules 310-390 are modules of hardware circuits implemented by one or more integrated circuits (ICs) of an electronic apparatus. Though the modules 310-390 are illustrated as being separate modules, some of the modules can be combined into a single module.

The video source 305 provides a raw video signal that presents pixel data of each video frame without compression. A subtractor 308 computes the difference between the raw video pixel data of the video source 305 and the predicted pixel data 313 from the motion compensation module 330 or intra-prediction module 325 as prediction residual 309. The transform module 310 converts the difference (or the residual pixel data or residual signal 308) into transform coefficients (e.g., by performing Discrete Cosine Transform, or DCT). The quantization module 311 quantizes the transform coefficients into quantized data (or quantized coefficients) 312, which is encoded into the bitstream 395 by the entropy encoder 390.

The inverse quantization module 314 de-quantizes the quantized data (or quantized coefficients) 312 to obtain transform coefficients, and the inverse transform module 315 performs inverse transform on the transform coefficients to produce reconstructed residual 319. The reconstructed residual 319 is added with the predicted pixel data 313 to produce reconstructed pixel data 317. In some embodiments, the reconstructed pixel data 317 is temporarily stored in a line buffer (not illustrated) for intra-picture prediction and spatial MV prediction. The reconstructed pixels are filtered by the in-loop filter 345 and stored in the reconstructed picture buffer 350. In some embodiments, the reconstructed picture buffer 350 is a storage external to the video encoder 300. In some embodiments, the reconstructed picture buffer 350 is a storage internal to the video encoder 300.

The intra-picture estimation module 320 performs intra-prediction based on the reconstructed pixel data 317 to produce intra prediction data. The intra-prediction data is provided to the entropy encoder 390 to be encoded into bitstream 395. The intra-prediction data is also used by the intra-prediction module 325 to produce the predicted pixel data 313.

The motion estimation module 335 performs inter-prediction by producing MVs to reference pixel data of previously decoded frames stored in the reconstructed picture buffer 350. These MVs are provided to the motion compensation module 330 to produce predicted pixel data.

Instead of encoding the complete actual MVs in the bitstream, the video encoder 300 uses MV prediction to generate predicted MVs, and the difference between the MVs used for motion compensation and the predicted MVs is encoded as residual motion data and stored in the bitstream 395.

The MV prediction module 375 generates the predicted MVs based on reference MVs that were generated for encoding previously video frames, i.e., the motion compensation MVs that were used to perform motion compensation. The MV prediction module 375 retrieves reference MVs from previous video frames from the MV buffer 365. The video encoder 300 stores the MVs generated for the current video frame in the MV buffer 365 as reference MVs for generating predicted MVs.

The MV prediction module 375 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 395 by the entropy encoder 390.

The entropy encoder 390 encodes various parameters and data into the bitstream 395 by using entropy-coding techniques such as context-adaptive binary arithmetic coding (CABAC) or Huffman encoding. The entropy encoder 390 encodes various header elements, flags, along with the quantized transform coefficients 312, and the residual motion data as syntax elements into the bitstream 395. The bitstream 395 is in turn stored in a storage device or transmitted to a decoder over a communications medium such as a network.

The in-loop filter 345 performs filtering or smoothing operations on the reconstructed pixel data 317 to reduce the artifacts of coding, particularly at boundaries of pixel blocks. In some embodiments, the filtering or smoothing operations performed by the in-loop filter 345 include deblock filter (DBF), sample adaptive offset (SAO), and/or adaptive loop filter (ALF). In some embodiments, luma mapping with chroma scaling (LMCS) is performed before the loop filters.

FIG. 4 conceptually illustrates portions of the video encoder 300 that implement controlled clipping. As illustrated, the encoder 300 implement four stages of control clipping: post-prediction (stage 410, after inter-prediction module 340 and intra-prediction module 325), post-reconstruction (stage 420, after reconstructed pixel data 317), post-deblocking (stage 427, after deblock filter 425), post-SAO (stage 430, after SAO 428), and post-ALF (stage 440, after ALF 435; ALF 435, SAO 428, and deblock filter 425 are parts of the in-loop filters 345).

During prediction, the prediction reference buffers of both the intra prediction module 325 and the inter prediction module 340 are used to store the predicted values 313 and generate the residuals 309 against the original sequence. After prediction, controlled clipping can be applied at the post-prediction stage 410 to the generated prediction 313, which is used to generate the residuals 309. The controlled clipping applied by the post-prediction stage 410 reduces the error level of the reconstructed residuals 319.

Before reconstruction, the residuals 309 are transformed and quantized into quantized coefficients 312 for transmission. The quantized coefficients 312 are inverse quantized and inverse transformed to become the reconstructed residual 319. This expands the dynamic range of the residuals, and it also changes the dynamic range of the reconstructed pixel values. If the range is known in advance, the dynamic range of the reconstructed pixel values can be restricted by controlled clipping at the post-reconstruction stage 420. This reduces the pixel error when the reconstructed pixel value exceeds the restricted range.

Deblocking and ALF change the reconstructed pixel values by filtering. The dynamic range of the filtered values might be changed. Controlled clipping at the post-deblock stage 430 and the post-ALF stage 440 can also restrict the pixel values in the correct range to minimize the expanded dynamic range.

In some embodiments, the maximum and minimum values (or other types of range definitions) used to constrain the sample values at each of the controlled clipping stages 410-440 are provided to the entropy encoder 390 and signaled in the bitstream 395 as syntax elements. In some embodiments, the maximum and minimum values used for LMCS operations are also provided to the entropy encoder 390 and signaled in the bitstream 395.

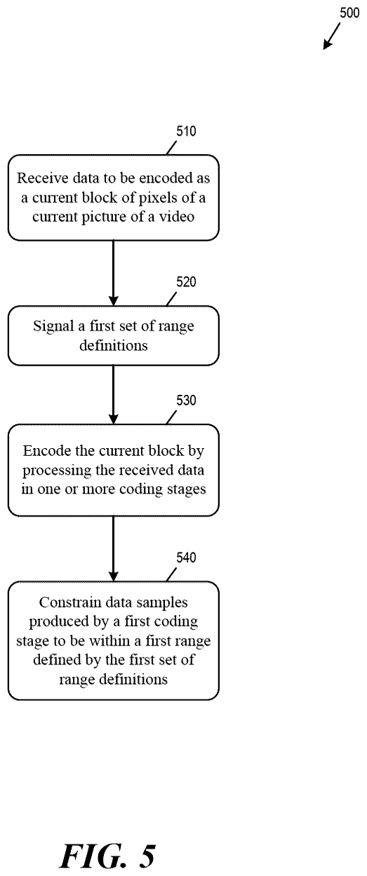

FIG. 5 conceptually illustrates a process 500 for performing adaptive sample clipping during video encoding. In some embodiments, one or more processing units (e.g., a processor) of a computing device implementing the encoder 300 performs the process 500 by executing instructions stored in a computer readable medium. In some embodiments, an electronic apparatus implementing the encoder 300 performs the process 500.

The encoder receives (at block 510) data to be encoded as a current block of pixels of a current picture of a video.

The encoder signal (at block 520) a first set of range definitions. The first set of range definitions may be enabled to be applied to data samples of a same slice, or a same tile, or a same coding tree unit (CTU) row, or a same coding unit, or any other higher-level entity in video coding hierarchy that includes the current block. In some embodiments, the first set of range definitions (and other flags related to adaptive sample clipping as described in Section II above) may be signaled in a slice header, a picture header, an adaptation parameter set (APS), and/or a picture parameter set (PPS).

The encoder encodes (at block 530) the current block by processing the received data in one or more coding stages. In some embodiments, the coding stages at which the adaptive sampling clipping is performed includes post-prediction, post-reconstruction, post-deblocking, post-ALF.

The encoder constrains (at block 540) data samples produced by a first coding stage to be within a first range defined by the first set of range definitions. The first set of range definitions may apply a clipping function upon the data samples produced by the first coding stage, specifically to impose a maximum allowed value and a minimum allowed value upon data samples produced by the first coding stage. In some embodiments, the maximum and minimum allowed values are applicable to luma and chroma components. In some embodiments, the maximum and minimum allowed values are applicable to samples of luma component only and not samples of chroma components. In some embodiments, data samples produced by a second coding stage are constrained to also be within the first numerical range defined by the first set of range definitions. In other words, a same set of maximum and minimum values are applied to multiple stages.

The video encoder may also signal a second set of range definitions, such that data samples produced by a second coding stage are constrained to be within a second numerical range defined by the second set of range definitions. In other words, different sets of maximum and minimum values may be applied to different stages. In some embodiments, the first set of range definitions is one set of a plurality of sets of range definitions signaled by the encoder, and the encoder selects the first set of range definitions from the plurality of sets of range definitions to be applied to the data samples produced by the first coding stage.

In some embodiments, the first set of range definitions is used for luma mapping with chroma scaling (LMCS), i.e., for defining a first range for mapping luma values from an original domain to a reshaped domain. The first set of range definitions may include a maximum value and a minimum value that is used for defining the first range and a number of non-zero codewords, and the number of non-zero codewords may not be a power of two number. A second set of range definitions may be used to define a second range for mapping luma values from the original domain to the reshaped domain.

In some embodiments, when adaptive sample clipping is applied, LMCS is disabled, and when LMCS is applied, adaptive sample clipping is disabled. In some embodiments, when LMCS is enabled, adaptive sample clipping is used in an in-loop filter stage (e.g., DBF, ALF, SAO). In some embodiments, when LMCS is disabled, adaptive sample clipping is applied to a prediction stage or a reconstruction stage of video encoding.

### IV. Example Video Decoder

In some embodiments, an encoder may signal (or generate) one or more syntax element in a bitstream, such that a decoder may parse said one or more syntax element from the bitstream.

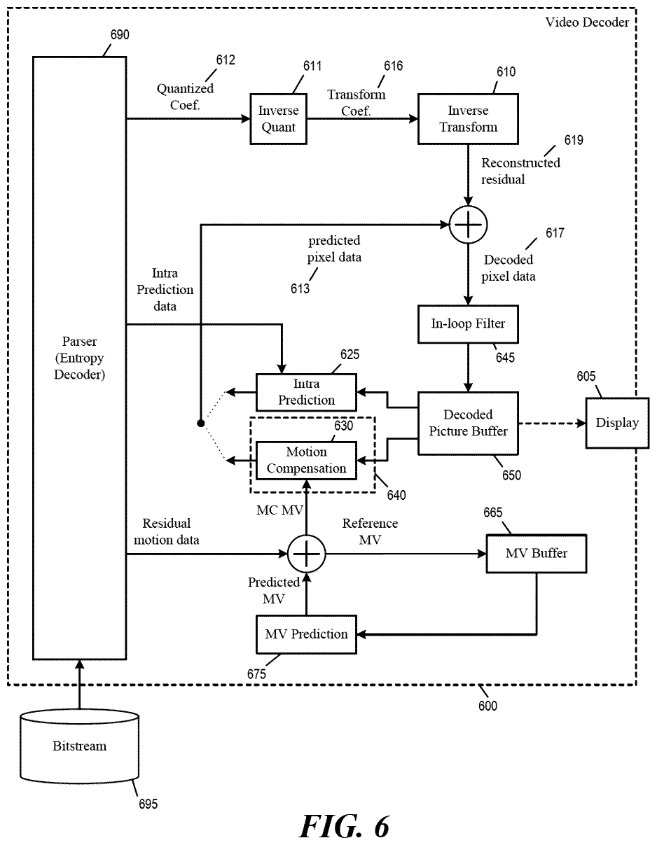

FIG. 6 illustrates an example video decoder 600 that may implement adaptive sample clipping. As illustrated, the video decoder 600 is an image-decoding or video-decoding circuit that receives a bitstream 695 and decodes the content of the bitstream into pixel data of video frames for display. The video decoder 600 has several components or modules for decoding the bitstream 695, including some components selected from an inverse quantization module 611, an inverse transform module 610, an intra-prediction module 625, a motion compensation module 630, an in-loop filter 645, a decoded picture buffer 650, a MV buffer 665, a MV prediction module 675, and a parser 690. The motion compensation module 630 is part of an inter-prediction module 640.

In some embodiments, the modules 610-690 are modules of software instructions being executed by one or more processing units (e.g., a processor) of a computing device. In some embodiments, the modules 610-690 are modules of hardware circuits implemented by one or more ICs of an electronic apparatus. Though the modules 610-690 are illustrated as being separate modules, some of the modules can be combined into a single module.

The parser 690 (or entropy decoder) receives the bitstream 695 and performs initial parsing according to the syntax defined by a video-coding or image-coding standard. The parsed syntax element includes various header elements, flags, as well as quantized data (or quantized coefficients) 612. The parser 690 parses out the various syntax elements by using entropy-coding techniques such as context-adaptive binary arithmetic coding (CABAC) or Huffman encoding.

The inverse quantization module 611 de-quantizes the quantized data (or quantized coefficients) 612 to obtain transform coefficients, and the inverse transform module 610 performs inverse transform on the transform coefficients 616 to produce reconstructed residual signal 619. The reconstructed residual signal 619 is added with predicted pixel data 613 from the intra-prediction module 625 or the motion compensation module 630 to produce decoded pixel data 617. The decoded pixels data are filtered by the in-loop filter 645 and stored in the decoded picture buffer 650. In some embodiments, the decoded picture buffer 650 is a storage external to the video decoder 600. In some embodiments, the decoded picture buffer 650 is a storage internal to the video decoder 600.

The intra-prediction module 625 receives intra-prediction data from bitstream 695 and according to which, produces the predicted pixel data 613 from the decoded pixel data 617 stored in the decoded picture buffer 650. In some embodiments, the decoded pixel data 617 is also stored in a line buffer (not illustrated) for intra-picture prediction and spatial MV prediction.

In some embodiments, the content of the decoded picture buffer 650 is used for display. A display device 605 either retrieves the content of the decoded picture buffer 650 for display directly, or retrieves the content of the decoded picture buffer to a display buffer. In some embodiments, the display device receives pixel values from the decoded picture buffer 650 through a pixel transport.

The motion compensation module 630 produces predicted pixel data 613 from the decoded pixel data 617 stored in the decoded picture buffer 650 according to motion compensation MVs (MC MVs). These motion compensation MVs are decoded by adding the residual motion data received from the bitstream 695 with predicted MVs received from the MV prediction module 675.

The MV prediction module 675 generates the predicted MVs based on reference MVs that were generated for decoding previous video frames, e.g., the motion compensation MVs that were used to perform motion compensation. The MV prediction module 675 retrieves the reference MVs of previous video frames from the MV buffer 665. The video decoder 600 stores the motion compensation MVs generated for decoding the current video frame in the MV buffer 665 as reference MVs for producing predicted MVs.

The in-loop filter 645 performs filtering or smoothing operations on the decoded pixel data 617 to reduce the artifacts of coding, particularly at boundaries of pixel blocks. In some embodiments, the filtering or smoothing operations performed by the in-loop filter 645 include deblock filter (DBF), sample adaptive offset (SAO), and/or adaptive loop filter (ALF). In some embodiments, luma mapping with chroma scaling (LMCS) is performed before the loop filters.

FIG. 7 conceptually illustrates portions of the video decoder 600 that implement controlled clipping. As illustrated, the decoder 600 implement four stages of control clipping: post-prediction (stage 710, after inter-prediction module 640 and intra-prediction module 625), post-reconstruction (stage 720, after reconstructed pixel data 617), post-deblocking (stage 727, after deblock filter 725), post-SAO (stage 730, after SAO 728), and post-ALF (stage 740, after ALF 735; ALF 735, SAO 728, and deblock filter 725 are parts of the in-loop filters 645).

During prediction, the prediction reference buffers of both the intra prediction module 625 and the inter prediction module 640 are used to store the predicted values 613. After prediction, controlled clipping can be applied at the post-prediction stage 710 to the generated prediction 613. The quantized coefficients 612 are inverse quantized and inverse transformed to become the reconstructed residual 619. The prediction 613 is combined with the reconstructed residual 619 to generate the decoded pixel data 617. The controlled clipping applied by the post-prediction stage 710 reduces the error level of the decoded pixel data 617. This expands the dynamic range of the decoded pixel values 617. If the range is known in advance, the dynamic range of the decoded pixel values 617 can be restricted by controlled clipping at the post-reconstruction stage 720. This reduces the pixel error when the decoded pixel value 617 exceeds the restricted range.

Deblocking and ALF change the reconstructed pixel values by filtering. The dynamic range of the filtered values might be changed. Controlled clipping at the post-deblock stage 730 and the post-ALF stage 740 can also restrict the pixel values in the correct range to minimize the expanded dynamic range.

In some embodiments, the maximum and minimum values (or other types of range definitions) used to constrain the sample values at each of the controlled clipping stages 710-740 are provided by the entropy decoder 690 and parsed from the bitstream 695 as syntax elements. In some embodiments, the maximum and minimum values used for LMCS operations are also provided by the entropy decoder 690 and parsed from the bitstream 695.

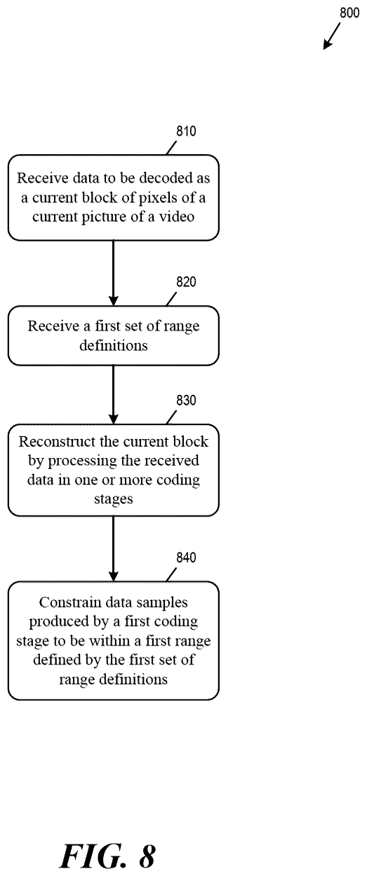

FIG. 8 conceptually illustrates a process 800 for performing adaptive sample clipping during video decoding. In some embodiments, one or more processing units (e.g., a processor) of a computing device implementing the decoder 600 performs the process 800 by executing instructions stored in a computer readable medium. In some embodiments, an electronic apparatus implementing the decoder 600 performs the process 800.

The decoder receives (at block 810) data to be decoded as a current block of pixels of a current picture of a video.

The decoder receives (at block 820) a first set of range definitions. The first set of range definitions may be enabled to be applied to data samples of a same slice, or a same tile, or a same coding tree unit (CTU) row, or a same coding unit, or any other higher-level entity in video coding hierarchy that includes the current block. In some embodiments, the first set of range definitions (and other flags related to adaptive sample clipping as described in Section II above) may be signaled in a slice header, a picture header, an adaptation parameter set (APS), and/or a picture parameter set (PPS).

The decoder reconstructs (at block 830) the current block by processing the received data in one or more coding stages. The decoder may then provide the reconstructed current block for display as part of the reconstructed current picture. In some embodiments, the coding stages at which the adaptive sampling clipping is performed includes post-prediction, post-reconstruction, post-deblocking, post-ALF.

The decoder constrains (at block 840) data samples produced by a first coding stage to be within a first range defined by the first set of range definitions. The first set of range definitions may apply a clipping function upon the data samples produced by the first coding stage, specifically to impose a maximum allowed value and a minimum allowed value upon data samples produced by the first coding stage. In some embodiments, the maximum and minimum allowed values are applicable to luma and chroma components. In some embodiments, the maximum and minimum allowed values are applicable to samples of luma component only and not samples of chroma components. In some embodiments, data samples produced by a second coding stage are constrained to also be within the first numerical range defined by the first set of range definitions. In other words, a same set of maximum and minimum values are applied to multiple stages.

The video decoder may also receive a second set of range definitions, such that data samples produced by a second coding stage are constrained to be within a second numerical range defined by the second set of range definitions. In other words, different sets of maximum and minimum values may be applied to different stages. In some embodiments, the first set of range definitions is one set of a plurality of sets of range definitions signaled by the decoder, and the decoder selects the first set of range definitions from the plurality of sets of range definitions to be applied to the data samples produced by the first coding stage.

In some embodiments, the first set of range definitions is used for LMCS, i.e., for defining a first range for mapping luma values from an original domain to a reshaped domain. The first set of range definitions may include a maximum value and a minimum value that is used for defining the first range and a number of non-zero codewords, and the number of non-zero codewords may not be a power of two number. A second set of range definitions may be used to define a second range for mapping luma values from the original domain to the reshaped domain.

In some embodiments, when adaptive sample clipping is applied, LMCS is disabled, and when LMCS is applied, adaptive sample clipping is disabled. In some embodiments, when LMCS is enabled, adaptive sample clipping is used in an in-loop filter stage (e.g., DBF, ALF, SAO). In some embodiments, when LMCS is disabled, adaptive sample clipping is applied to a prediction stage or a reconstruction stage of video decoding.

### V. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

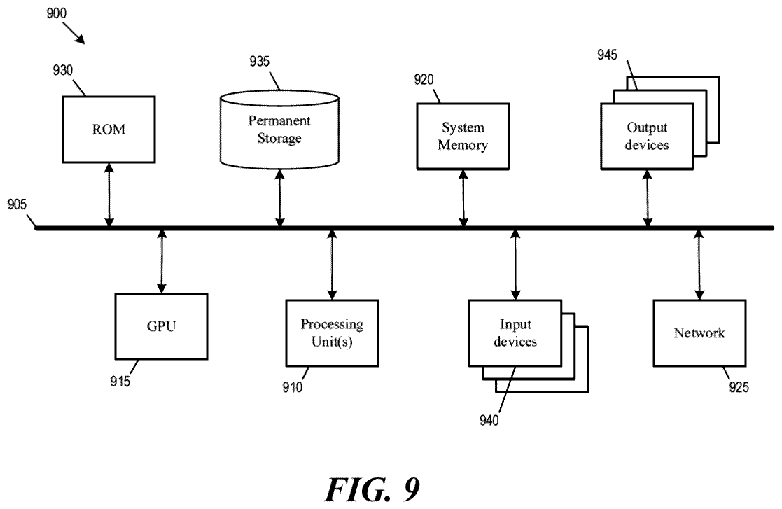

FIG. 9 conceptually illustrates an electronic system 900 with which some embodiments of the present disclosure are implemented. The electronic system 900 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 900 includes a bus 905, processing unit(s) 910, a graphics-processing unit (GPU) 915, a system memory 920, a network 925, a read-only memory 930, a permanent storage device 935, input devices 940, and output devices 945.

The bus 905 collectively represents all system, peripheral, and chipset buses that communicatively connect the numerous internal devices of the electronic system 900. For instance, the bus 905 communicatively connects the processing unit(s) 910 with the GPU 915, the read-only memory 930, the system memory 920, and the permanent storage device 935.

From these various memory units, the processing unit(s) 910 retrieves instructions to execute and data to process in order to execute the processes of the present disclosure. The processing unit(s) may be a single processor or a multi-core processor in different embodiments. Some instructions are passed to and executed by the GPU 915. The GPU 915 can offload various computations or complement the image processing provided by the processing unit(s) 910.

The read-only-memory (ROM) 930 stores static data and instructions that are used by the processing unit(s) 910 and other modules of the electronic system. The permanent storage device 935, on the other hand, is a read-and-write memory device. This device is a non-volatile memory unit that stores instructions and data even when the electronic system 900 is off. Some embodiments of the present disclosure use a mass-storage device (such as a magnetic or optical disk and its corresponding disk drive) as the permanent storage device 935.

Other embodiments use a removable storage device (such as a floppy disk, flash memory device, etc., and its corresponding disk drive) as the permanent storage device. Like the permanent storage device 935, the system memory 920 is a read-and-write memory device. However, unlike storage device 935, the system memory 920 is a volatile read-and-write memory, such a random access memory. The system memory 920 stores some of the instructions and data that the processor uses at runtime. In some embodiments, processes in accordance with the present disclosure are stored in the system memory 920, the permanent storage device 935, and/or the read-only memory 930. For example, the various memory units include instructions for processing multimedia clips in accordance with some embodiments. From these various memory units, the processing unit(s) 910 retrieves instructions to execute and data to process in order to execute the processes of some embodiments.

The bus 905 also connects to the input and output devices 940 and 945. The input devices 940 enable the user to communicate information and select commands to the electronic system. The input devices 940 include alphanumeric keyboards and pointing devices (also called “cursor control devices”), cameras (e.g., webcams), microphones or similar devices for receiving voice commands, etc. The output devices 945 display images generated by the electronic system or otherwise output data. The output devices 945 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 9, bus 905 also couples electronic system 900 to a network 925 through a network adapter (not shown). In this manner, the computer can be a part of a network of computers (such as a local area network (“LAN”), a wide area network (“WAN”), or an Intranet, or a network of networks, such as the Internet. Any or all components of electronic system 900 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 5 and FIG. 8) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video coding method comprising:
receiving data to be encoded or decoded as a current block of pixels of a current picture of a video;
signaling or receiving a first set of range definitions; and
encoding or decoding the current block by processing the received data in one or more coding stages,
wherein data samples produced by a first coding stage are constrained to be within a first numerical range defined by the first set of range definitions.

2. The video coding method of claim 1, wherein the first set of range definitions applies a clipping function upon the data samples produced by the first coding stage.

3. The video coding method of claim 1, wherein the first set of range definitions imposes a maximum allowed value and a minimum allowed value upon data samples produced by the first coding stage.

4. The video coding method of claim 3, wherein the maximum and minimum allowed values are applicable to luma and chroma components.

5. The video coding method of claim 3, wherein the maximum and minimum allowed values are applicable to samples of luma component only and not samples of chroma components.

6. The video coding method of claim 3, wherein differences between the maximum and minimum allowed values and predefined maximum and minimum values are signaled by an encoder or decoded by a decoder.

7. The video coding method of claim 1, wherein data samples produced by a second coding stage are constrained to be within the first numerical range defined by the first set of range definitions.

8. The video coding method of claim 1, further comprising signaling or receiving a second set of range definitions, wherein data samples produced by a second coding stage are constrained to be within a second numerical range defined by the second set of range definitions.

9. The video coding method of claim 1, wherein the first set of range definitions is one set of a plurality of sets of range definitions received or signaled, the method further comprising selecting the first set of range definitions from the plurality of sets of range definitions to be applied to the data samples produced by the first coding stage.

10. The video coding method of claim 1, wherein the first set of range definitions is enabled to be applied to data samples of a same slice, or a same tile, or a same coding tree unit (CTU) row, or a same coding unit.

11. The video coding method of claim 1, wherein the first set of range definitions is used for defining a first range for mapping luma values from an original domain to a reshaped domain.

12. The video coding method of claim 10, wherein the first set of range definitions comprises a maximum value and a minimum value for defining the first range and a number of non-zero codewords.

13. The video coding method of claim 11, wherein the number of non-zero codewords is not a power of two number.

14. The video coding method of claim 10, wherein a second set of range definitions is used for defining a second range for mapping luma values from the original domain to the reshaped domain.

15. The video coding method of claim 1, wherein when adaptive sample clipping is applied, luma mapping with chroma scaling (LMCS) is disabled, and when LMCS is applied, adaptive sample clipping is disabled.

16. The video coding method of claim 1, wherein when luma mapping with chroma scaling (LMCS) is enabled, adaptive sample clipping is used in an in-loop filter stage.

17. The video coding method of claim 1, where when luma mapping with chroma scaling (LMCS) is disabled, adaptive sample clipping is applied to a prediction stage or a reconstruction stage.

18. The video coding method of claim 1, wherein the first set of range definitions is signaled in at least one of a slice header, a picture header, an adaptation parameter set (APS), and a picture parameter set (PPS).

19. An electronic apparatus comprising:
a video coder circuit configured to perform operations comprising:
receiving data to be encoded or decoded as a current block of pixels of a current picture of a video;
signaling or receiving a first set of range definitions; and
encoding or decoding the current block by processing the received data in one or more coding stages,
wherein data samples produced by a first coding stage are constrained to be within a first numerical range defined by the first set of range definitions.

20. A video decoding method comprising:
receiving data to be decoded as a current block of pixels of a current picture of a video;
receiving a first set of range definitions; and
reconstructing the current block by processing the received data in one or more coding stages,
wherein data samples produced by a first coding stage are constrained to be within a first numerical range defined by the first set of range definitions.

21. A video encoding method comprising:
receiving data to be encoded as a current block of pixels of a current picture of a video;
signaling a first set of range definitions; and
encoding the current block by processing the received data in one or more coding stages,
wherein data samples produced by a first coding stage are constrained to be within a first numerical range defined by the first set of range definitions.
